(19) United States
(12) Patent Application Publication
(10) Pub. No.: US 2016/0362644 A1
(43) Pub. Date: Dec. 15, 2016

(54) LIQUID DETERGENT INCLUDING POLYMERS FOR INCREASING THE FRAGRANCE PERFORMANCE

(71) Applicant: Henkel AG & Co. KGaA, Duesseldorf (DE)

(72) Inventors: Georg Meine, Mettmann (DE); Ralf Bunn, Duesseldorf (DE)

(73) Assignee: Henkel AG & Co. KGaA, Duesseldorf (DE)

(21) Appl. No.: 15/247,246

(22) Filed: Aug. 25, 2016

Related U.S. Application Data
(63) Continuation of application No. PCT/EP2015/056010, filed on Mar. 20, 2015.

(30) Foreign Application Priority Data
Mar. 31, 2014 (DE) 10 2014 206 064.8

(51) Int. Cl. C11D 3/50; C11D 3/37; C11D 11/00; C11D 3/22

(52) U.S. Cl. CPC C11D 3/50; C11D 3/225; C11D 3/3707; C11D 3/3776; C11D 11/0017

(57) ABSTRACT

The present invention relates to the use of at least one polymer for improving the adsorption of odorous substances onto textiles in a washing method and to a liquid detergent that contains the at least one polymer and at least one odorous substance, and to a washing method in which the at least one polymer is used.

### FIELD OF THE INVENTION

The present invention generally relates to the use of at least one polymer for improving the adsorption of odorous substances onto textiles in a washing method and to a liquid detergent that contains the at least one polymer and at least one odorous substance, and to a washing method in which the at least one polymer is used.

### BACKGROUND OF THE INVENTION

Besides constituents which completely remove dirt, detergents usually contain odorous substances which are intended to give the detergents a pleasant scent and to cover bad smells. The consumer wants the washed textile article to have a scent that is as pleasant and long-lasting as possible. In conventional liquid detergents, only small amounts of the odorous substances are transferred to the textile article since a majority of said substances is adsorbed by constituents of the detergent, such as builders and surfactants for example. The washed textile therefore has little scent, and the scent lasts only for a short duration. In order to increase the intensity of the scent, therefore, larger amounts of odorous substances are used, but this is associated with additional costs. A general aim is therefore to improve the adsorbabilty of odorous substances onto textiles.

The object of the present invention is therefore to provide a detergent which gives the washed laundry an increased ability to adsorb odorous substances.

It has surprisingly been found that the adsorbability of odorous substances onto washed textiles is increased, and the textiles smell thereof for longer, if in the washing process use is made of a detergent which contains at least one polymer selected from the group consisting of cotton, cellulose, cellulose ether, lignin, polyvinyl acetate-polyalkylene glycol copolymer, polyvinylpyrrolidone-polyvinylimidazole copolymer, polyalkylene glycol polyester, polyamine and a mixture thereof.

Furthermore, other desirable features and characteristics of the present invention will become apparent from the subsequent detailed description of the invention and the appended claims, taken in conjunction with this background of the invention.

### BRIEF SUMMARY OF THE INVENTION

The use of at least one polymer selected from the group consisting of cotton, cellulose, cellulose ether, lignin, polyvinyl acetate-polyalkylene glycol copolymer, polyvinylpyrrolidone-polyvinylimidazole copolymer, polyalkylene glycol polyester, polyamine and a mixture thereof to improve the adsorption of odorous substances onto textiles in a washing method in which a liquid detergent is used, wherein the detergent contains the at least one polymer and at least one odorous substance.

A liquid detergent containing at least one polymer selected from the group consisting of cotton, cellulose, cellulose ether, lignin, polyvinyl acetate-polyalkylene glycol copolymer, polyvinylpyrrolidone-polyvinylimidazole copolymer, polyalkylene glycol polyester, polyamine and a mixture thereof and at least one odorous substance.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In a first aspect, the present invention relates to the use of at least one polymer selected from the group consisting of cotton, cellulose, cellulose ether, lignin, polyvinyl acetate-polyalkylene glycol copolymer, polyvinylpyrrolidone-polyvinylimidazole copolymer, polyalkylene glycol polyester, polyamine and a mixture thereof to improve the adsorption of odorous substances onto textiles in a washing method in which a liquid detergent is used, wherein the liquid detergent contains the at least one polymer and at least one odorous substance.

In a further aspect, the invention relates to a washing method comprising the method steps
(a) providing a washing solution including a liquid detergent as defined herein, and
(b) bringing a textile into contact with the washing solution according to (a).

In a further aspect, the present invention relates to a liquid detergent which contains at least one polymer selected from the group consisting of cotton, cellulose, cellulose ether, lignin, polyvinyl acetate-polyalkylene glycol copolymer, polyvinylpyrrolidone-polyvinylimidazole copolymer, polyalkylene glycol polyester, polyamine and a mixture thereof and at least one odorous substance.

By using the polymer described herein, the adsorption of odorous substances onto the washed textile article is increased. This increase leads to a more intensive and longer-lasting scent on the textile. Alternatively, a smaller amount of odorous substances can be used to achieve a scent intensity and duration comparable to conventional detergents.

The detergents may be detergents for textiles, carpets or natural fibers. Liquid detergents in the context of the invention also include washing aids which, in the hand washing or machine washing of textiles, are added to the actual detergent in order to achieve a further effect. Detergents in the context of the invention also include pre-treatment and aftertreatment agents for textiles, that is to say those agents with which the laundry article is brought into contact before the actual washing operation, for example in order to dissolve stubborn stains, and also those agents which, in a step downstream of the actual washing of the textiles, gives the washed article further desirable properties such as a pleasant feel, freedom from creases or a low static charge. The last-mentioned agents include, inter alia, fabric softeners. In preferred embodiments of the invention, however, the agent is a liquid (all-in-one) detergent.

The present invention relates to the use of at least one polymer selected from the group consisting of cotton, cellulose, cellulose ether, lignin, polyvinyl acetate-polyalkylene glycol copolymer, polyvinylpyrrolidone-polyvinylimidazole copolymer, polyalkylene glycol polyester, polyamine and a mixture thereof to increase the adsorption of odorous substances onto textiles in a washing method in which use is made of a liquid detergent which contains the at least one polymer in combination with at least one odorous substance.

These and other aspects, features and advantages of the invention will become apparent to the person skilled in the art upon studying the following detailed description and claims. Any feature from any one aspect of the invention can be used in any other aspect of the invention. Furthermore, it goes without saying that the examples contained herein are intended to describe and illustrate the invention but do not restrict the latter, and in particular the invention is not limited to these examples. Unless indicated otherwise, all stated percentages are percentages by weight. Numerical ranges specified in the format “from x to y” include the values mentioned. If multiple numerical ranges in this format are specified, it goes without saying that all ranges obtained by combining the different end points are also encompassed.

As used herein, “at least one” refers to 1 or more, for example 1, 2, 3, 4, 5, 6, 7, 8, 9 or more. In connection with constituents of the compositions described herein, said expression refers not to the absolute amount of molecules but rather to the type of constituent. For example, “at least one polymer” therefore means one or more polymers, that is to say one or more different types of polymers. Together with specified amounts, the specified amounts refer to the total amount of the designated type of constituent, as already defined above.

As already mentioned above, the polymers according to the invention are selected from the group consisting of cotton, cellulose, cellulose ether, lignin, polyvinyl acetate-polyalkylene glycol copolymer, polyvinylpyrrolidone-polyvinylimidazole copolymer, polyalkylene glycol polyester, polyamine and a mixture thereof. Without being bound to a particular theory, it is assumed that the polymers described herein can, due to their chemical composition which is similar or identical to the textile article, already adsorb the odorous substances in the liquid detergent and draw it onto the washed textile article. Furthermore, the surface area of the textile is increased as a result of the polymers being drawn onto the textile article, so that the latter now adsorbs more odorous substances. According to the invention, use may in principle be made of all polymers known to the person skilled in the art which have an identical or similar chemical composition to the treated textile article and/or of polymers which can draw onto the textile.

According to the invention, use may be made of cotton, in particular cotton fibers. Cotton is a natural fiber which is obtained from the seed hair of plants of the genus Gossypium. Besides the main constituent cellulose, cotton also contains wax, protein and other plant residues. The cotton as described herein can be used in untreated form, that is to say in “natural” form. However, it may also be treated by conventional chemical and/or mechanical methods before being used according to the invention. The size and/or length of the cotton or cotton fibers used may vary. Preferably, the cotton fibers used have a length of less than 1 mm, preferably less than 0.01 mm, particularly preferably a length of from 100 nm to 0.05 mm. The width of the cotton or cotton fiber corresponding to the length is always less than the length. The use of cotton, in particular cotton fibers, as the polymer in the context of the invention is particularly advantageous for increasing the adsorbability of odorous substances onto cotton or cotton-like textiles.

Furthermore, the polymer used may also be cellulose. As already mentioned, cellulose is the main constituent of cotton. Cellulose is unbranched and consists of β-D-glucose units which are linked to one another by 1,4-glycosidic bonds. Cellulose is a polymer having units of formula 1

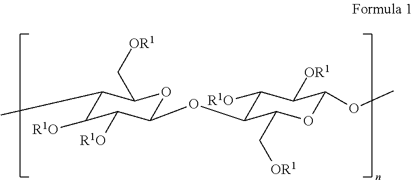

Herein, according to the invention, n is 25 to 1,000,000, preferably 50 to 50,000, and R¹ is hydrogen. In one application, the cellulose polymers described herein may also be a mixture of celluloses with different n, that is to say different molecular weights. Cellulose is particularly advantageous for increasing the adsorbability of odorous substances onto cellulose-like textiles, such as cotton for example.

Cellulose ethers are another polymer according to the invention, and these are likewise polymers having units of formula 1, wherein each R¹ independently is H or a linear or branched alkyl having 1 to 6 C atoms, preferably having 1 to 4 C atoms. The ethers may also be partial ethers, that is to say that not every R¹ is an alkyl group but rather R¹ in some cases may also be H. In the cellulose ethers, however, at least one R¹ is not hydrogen. Preferably, R¹ is selected from methyl, ethyl and isopropyl. As an alkyl group, R¹ is also optionally substituted with —OH, —COOH and/or —N⁺(R^{a})(R^{b})(R^{c}) X⁻, wherein each R^{a}, R^{b} and R^{c} independently of one another is a linear or branched alkyl having 1 to 6 C atoms, preferably 1 to 4 C atoms, preferably methyl and/or ethyl. X⁻ may be any anion. According to the invention, n in this case is 25 to 1,000,000, preferably 50 to 50,000. It should be pointed out here that, both in a cellulose ether unit according to formula 1 and in a cellulose ether polymer, each R¹ may be different or else identical. Furthermore, the cellulose ethers described herein may in one application be a mixture of cellulose ethers with different n, that is to say different molecular weights. In one preferred embodiment of the present invention, the cellulose ether is selected from the group consisting of hydroxypropyl methyl cellulose (HPMC), methyl cellulose (MC), methyl ethyl cellulose (MEC), carboxyl methyl cellulose (CMC), 2-hydroxyethyl-2-[2-hydroxy-3-(trimethylammonio)propoxy]ethyl-2-hydroxy-3 -trimethylammonio)-propyl cellulose ether chloride and a mixture thereof. Cellulose ethers are particularly advantageous for increasing the adsorbability of odorous substances onto cellulose ether-containing or cellulose ether-like textiles.

As has already been described, X⁻ may be any anion and serves primarily for charge balancing. As the anion, use may be made of any anion which is known to the person skilled in the art and which is suitable for this purpose. In one preferred embodiment, X⁻ is selected from the group consisting of F⁻, Cl⁻, Br⁻, I⁻, HSO₃⁻, SO₃²⁻, SO₄²⁻, O₂⁻, NO₃⁻, BF₄⁻, PF₆⁻, ClO₄⁻, OTf⁻, acetate, citrate, formate, glutarate, lactate, malate, malonate, oxalate, pyruvate and tartrate. In one preferred embodiment according to the invention, X⁻ is selected from the group consisting of F⁻, Cl⁻, Br⁻, I⁻, citrate and acetate.

Lignins can also be used as polymers. Lignins are biopolymers which are a constituent of plant cell walls. In nature, lignins are built up enzymatically from the monolignols cumaryl alcohol, coniferyl alcohol and sinapyl alcohol, wherein these monomers link covalently to one another via C—C and ether bonds and the phenolic polymer is formed as a result. According to the invention, this polymer may exist with a molar mass of from 1000 to 1,000,000 g/mol, preferably 5000 to 250,000 g/mol. The form of the lignin may vary; for example, it may be used in the form of fibers, beads or flakes. Preferably, the lignin particle used has a diameter smaller than 0.5 mm, preferably from 500 nm to 0.05 mm. Here, the diameter is the greatest distance between 2 points located on the surface of the fiber, bead or flake. The lignin as described herein may be used in untreated form, that is to say in “natural” form. However, it may also be treated by conventional chemical and/or mechanical methods before being used according to the invention. According to the invention, lignin is advantageous for increasing the adsorbability of odorous substances onto lignin-containing or lignin-like textiles and/or textiles which contain aromatic compounds.

The polyvinyl acetate-polyalkylene glycol copolymer, as described herein, is a polymer which contains at least one polyvinyl acetate and at least one polyalkylene glycol. According to the invention, this copolymer may exist as a statistical copolymer, in which the monomers are distributed statistically, as a block copolymer, which consists of relatively long sequences or blocks of each monomer, or as a graft copolymer. In one preferred embodiment, this copolymer is a graft polymer obtainable from a reaction mixture which contains at least one polyalkylene glycol and at least one vinyl acetate. The copolymer may be a graft copolymer of polyvinyl acetate and polyalkylene glycol, which is obtainable by grafting at least one polyalkylene glycol having a molecular weight of 200 to 200,000 g/mol, preferably 5000 to 100,000 g/mol, with a vinyl acetate having a molecular weight of 80 to 200,000 g/mol, preferably 200 to 100,000 g/mol, in a weight ratio of 20:1 to 1:20, preferably 10:1 to 1:10, more preferably 5:1 to 1:5), or vice versa, that is to say the polyalkylene glycol is grafted onto the vinyl acetate. In general graft copolymers have a main chain of a first monomer type, onto which a monomer or polymer of a second type is affixed or “grafted”. These copolymers have a comb-like shape. According to the invention, the polyalkylene glycol used may be polyethylene glycol, polypropylene glycol and/or polybutylene glycol or mixtures thereof, preferably polyethylene glycol. However, the polyalkylene glycol as described herein may also be obtained from a mixture of different monomer units, for example from ethylene oxide, propylene oxide and butylene oxide. The alkylene oxide units may be statistically distributed in the polymer or may exist in the form of blocks, for example as block copolymers of ethylene oxide and propylene oxide, block copolymers of ethylene oxide and butylene oxide and also block copolymers of ethylene oxide, propylene oxide and butylene oxide. In one preferred embodiment, the polyalkylene glycol is polyethylene glycol. In one preferred embodiment, the polyalkylene glycol represents the main chain, onto which the vinyl acetate is grafted. In one embodiment, therefore, the polyalkylene glycol is obtained in a first polymerization step and the vinyl acetate is grafted on in a second polymerization step. The polymerization may be initiated by radicals or also photolytically. To this end, use may be made of all radical initiators which are known to the person skilled in the art and which are suitable for this purpose. In general, radical initiators break down under certain conditions into radicals and then initiate the polymerization. Photolytic polymerization is preferably initiated by energy-rich irradiation of the reaction mixture. Suitable radical initiators are all initiators which are known to the person skilled in the art, especially organic peroxides, such as for example azobisisobutyronitrile, diacetyl peroxide, dibenzoyl peroxide, succinyl peroxide, di-tert-butyl peroxide, tert-butyl perbenzoate, cumene hydroperoxide, diisopropyl peroxydicarbonate, didecanoyl peroxide, tert-butyl perisobutyrate, tert-butyl hydroperoxide and mixtures thereof. The polymerization may take place in the temperature range from 50 to 200° C. Preferably, the graft copolymerization is carried out at 70 to 140° C. It may also take place under pressure. The graft copolymerization may be carried out in the manner of a solution polymerization in a solvent, such as for example in alcohols, such as methanol, ethanol, n-propanol, isopropanol, n-butanol, sec-butanol, tert-butanol, n-hexanol and cyclohexanol, and also glycols, such as propylene glycol, ethylene glycol and butylene glycol, as well as the methyl or ethyl ether of the divalent alcohols, and also dioxane. The polyalkylene glycol may thus serve both as solvent and as educt. Preferably, the graft copolymerization is carried out in water as the solvent. With this production method, additives may optionally be contained; for example, emulsifiers may be used. The graft copolymers may optionally be saponified, as a result of which vinyl alcohol units are produced in the graft copolymer. This is carried out by adding a base, such as NaOH or KOH, and/or by adding acids, and optionally heating the mixture. As already mentioned, according to the invention the polyvinyl acetate-polyalkylene glycol copolymer described herein may also exist as a statistical copolymer or as a block copolymer. For these statistical copolymers and block polymers, all details concerning the molecular weight, weight ratio, production method, in particular with regard to the temperature conditions, solvent and type of production method, in particular with regard to the radical initiator, and the saponification of the graft copolymer described above can be transferred to these types of copolymer. According to the invention, the polyvinyl acetate-polyalkylene glycol copolymer is particularly advantageous for increasing the adsorbability of odorous substances onto textiles which consist of or contain identical or similar compounds.

Another polymer which can be used according to the invention is a polyvinylpyrrolidone-polyvinylimidazole copolymer. This copolymer may exist as a statistical polymer, block copolymer or as a graft copolymer. For this copolymer, all details concerning the molecular weight, weight ratio, production method, in particular with regard to the temperature conditions, solvent and type of production method, in particular with regard to the radical initiator, and the saponification of the polyvinyl acetate-polyalkylene glycol copolymer described above can be transferred to the polyvinylpyrrolidone-polyvinylimidazole copolymer. The molar mass preferably lies in the range from 200 to 200,000 g/mol, preferably 5000 to 100,000 g/mol.

Polyalkylene glycol polyesters are another polymer which can be used according to the invention. This polyester is obtainable from a reaction mixture which contains at least one polyol and at least one polycarboxylic acid, preferably aryl polycarboxylic acid. The at least one polyol is preferably an alkyl diol having 2 to 6 C atoms, preferably ethylene glycol, propanediol or butylene glycol and particularly preferably ethylene glycol. In principle, all isomeric forms of the polyols disclosed herein can be used. The —OH groups may be vicinal or else isolated from one another in a polyol. Preferably, the —OH groups are located at the terminal ends of the respective polyol. Therefore, the ethylene glycol is preferably 1,2-ethanediol and the propylene glycol is preferably 1,3-propanediol. The polyol may also have more than 2 -OH groups, for example 3, 4, 5 or more. Such polyols include for example glycerol or xylitol. The at least one polycarboxylic acid is preferably an aryl polycarboxylic acid having 5 to 14 C atoms, preferably 6 C atoms. Furthermore, the at least one (aryl) polycarboxylic acid contains 2 to 5 —COOH, preferably 2 or 3 —COOH and more preferably 2 —COOH substituted. With particular preference, the at least one aryl polycarboxylic acid is phthalic acid, isophthalic acid and/or terephthalic acid, and even more preferably terephthalic acid. The molecular ratio of the at least one polyol and of the at least one aryl polycarboxylic acid is 20:1 to 1:20, preferably 10:1 to 1:10, more preferably 7:1 to 1:7. The reaction described herein is a polycondensation which is established in the prior art. All known techniques and chemicals can be used for this purpose. For instance, the polycondensation may take place azeotropically or catalytically. In a further established method, the carboxylic acid is activated by customary compounds, for example SOCl₂ or COCl₂, and is preferably in the form of a carboxylic acid chloride and is reacted with the relevant polyol. The polymer may have a molar mass of 1000 to 100,000 g/mol, preferably 2000 to 25,000 g/mol. It should be pointed out here that the reaction mixture disclosed herein may contain both a plurality of different polyols and also a plurality of different aryl polycarboxylic acids. For instance, the polyols may differ from one another in terms of their branching, chain length and also in the position of the —OH groups. Furthermore, the aryls used may differ in the number of C atoms therein and in the number and arrangement of the —COOH groups. If the polyalkylene glycol polyester used is to be linear, for example, it is advantageous to use an alkyl diol having terminal —OH groups and an aryl dicarboxylic acid having 2 —COOH which are as far away from one another as possible on the aryl dicarboxylic acid. If a branched structure of the polyester is to be obtained, use may be made of a polyol having more than 2 —OH groups and/or an aryl polycarboxylic acid having more than 2 —COOH groups. According to the invention, the polyalkylene glycol polyester is particularly advantageous for increasing the adsorbability of odorous substances onto polyester textiles.

Polyamine may also be used as the polymer. The polyamine disclosed herein may be a linear or branched polyamine. According to the invention, these polyamines contain 10 to 10,000, preferably 50 to 5000, monomer units as well as primary, secondary and tertiary amine groups. Polyamines which are preferred according to the invention can be produced from the monomers thereof, such as for example 2-aminoethyl acrylate, 2-aminoethyl methacrylate, 3-aminopropyl acrylate, 3-aminopropyl methacrylate, 2-N,N-dimethylaminoethyl acrylate, 2-N,N-dimethylaminoethyl methacrylate, 3-N,N-dimethylaminopropyl acrylate, 3-N,N-dimethylaminopropyl methacrylate, 2-aminoethyl acrylamide, 2-aminoethyl methacrylamide, 3-aminopropyl acrylamide, 3-aminopropyl methacrylamide, 2-N,N-dimethylaminoethyl acrylamide, 2-N,N-dimethylaminoethyl methacrylamide, 3-N,N-dimethylaminopropyl acrylamide, 3-N,N-dimethylaminopropyl methacrylamide or mixtures thereof.

It should be pointed out here that the choice of polymer used depends on the textile article, the adsorbability of which for odorous substances is to be increased. The polymer should have a chemical composition and structure which is similar or identical to that of the textile. Since textiles often have more than one constituent, use may be made of polymer mixtures which may differ in the amounts used.

In one preferred embodiment of the present invention, the liquid detergent contains, based on its total weight, 0.001 to 50% by weight, preferably 0.01 to 10% by weight, more preferably 2% by weight of the at least one polymer. It should be pointed out here that the liquid detergent may contain a plurality of the polymers described herein. In this case, the amounts specified above then refer to the total amount of polymer in the detergent.

The odorous substance, the adsorption of which onto the textiles is to be improved, may likewise be contained in the detergent or may be added separately. However, it is preferred that it is contained directly in the detergent. The odorous substance may in particular be selected from the group comprising fragrances of natural or synthetic origin, readily volatile fragrances, higher-boiling fragrances, solid fragrances and/or strongly adhering fragrances.

Strongly adhering odorants which can be used with advantage in the context of the present invention are for example essential oils such as angelica root oil, anise oil, arnica flower oil, basil oil, bay oil, bergamot oil, champaca flower oil, noble fir oil, noble fir cone oil, elemy oil, eucalyptus oil, fennel oil, spruce needle oil, galbanum oil, geranium oil, ginger grass oil, guaiac wood oil, gurjun balsam oil, helichrysum oil, ho oil, ginger oil, iris oil, cajeput oil, calmus oil, chamomile oil, camphor oil, canaga oil, cardamom oil, cassia oil, pine needle oil, copaiva balsam oil, coriander oil, spearmint oil, caraway oil, cumin oil, lavender oil, lemongrass oil, lime oil, mandarin oil, melissa oil, muscat kernel oil, myrrh oil, oil of cloves, neroli oil, niaouli oil, olibanum oil, orange oil, origanum oil, palmarosa oil, patchouli oil, peru balsam oil, petit grain oil, pepper oil, peppermint oil, pimento oil, pine oil, rose oil, rosemary oil, sandalwood oil, celery oil, spike oil, star anise oil, terpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil.

However, higher-boiling or solid odorants of natural or synthetic origin can also be used in the context of the present invention as strongly adhering odorants or odorant mixtures, that is to say fragrances. These compounds include the following compounds as well as mixtures thereof: ambrettolide, α-amylcinnamaldehyde, anethole, anisaldehyde, anisyl alcohol, anisole, methyl anthranilate, acetophenone, benzylacetone, benzaldehyde, ethyl benzoate, benzophenone, benzyl alcohol, benzyl acetate, benzyl benzoate, benzyl formate, benzyl valerate, borneol, bornyl acetate, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, methyl heptyne carboxylate, heptaldehyde, hydroquinone dimethyl ether, hydroxycinnamaldehyde, hydroxycinnamal alcohol, indole, irone, isoeugenol, isoeugenol methyl ether, isosafrol, jasmone, camphor, carvacrol, carvone, p-cresol methyl ether, coumarin, p-methoxyacetophenone, methyl n-amyl ketone, methyl methylanthranilate, p-methylacetophenone, methylchavicol, p-methylquinoline, methyl β-naphthyl ketone, methyl-n-nonylacetaldehyde, methyl n-nonyl ketone, muscone, β-naphthol ethyl ether, β-naphthol methyl ether, nerol, nitrobenzene, n-nonylaldehyde, nonyl alcohol, n-octylaldehyde, p-oxyacetophenone, pentadecanolide, β-phenylethyl alcohol, phenylacetaldehyde dimethyl acetal, phenylacetic acid, pulegone, safrol, isoamyl salicylate, methyl salicylate, hexyl salicylate, cyclohexyl salicylate, santalol, skatole, terpineol, thymene, thymol, γ-undelactone, vanillin, veratrum aldehyde, cinnamaldehyde, cinnamal alcohol, cinnamic acid, ethyl cinnamate and benzyl cinnamate.

The more readily volatile fragrances include in particular the lower-boiling odorants of natural or synthetic origin, which can be used alone or in mixtures. Examples of more readily volatile fragrances are alkyl isothiocyanates (alkyl mustard oils), butanedione, limonene, linalool, linayl acetate and propionate, menthol, menthone, methyl-n-heptenone, phellandrene, phenylacetaldehyde, terpinyl acetate, citral and citronellal.

The detergent may advantageously contain anionic and/or non-ionic surfactants.

Suitable anionic surfactants include, without being limited thereto, alkylbenzene sulfonates, olefin sulfonates, alkane sulfonates, fatty alcohol sulfates, fatty alcohol ether sulfates or a mixture of two or more of these anionic surfactants. Among these anionic surfactants, particular preference is given to alkylbenzene sulfonates, fatty alcohol ether sulfates and mixtures thereof. Further suitable anionic surfactants are soaps, that is to say salts of fatty acids, in particular the Na or K salts of fatty acids having 12 to 16 C atoms. Soaps may in particular have an advantageous effect on the cold washing performance.

As surfactants of the sulfonate type, consideration is preferably given here to alkylbenzene sulfonates, olefin sulfonates, that is to say mixtures of alkene and hydroxyalkane sulfonates and disulfonates, as obtained for example from monoolefins having 12 to 18 C atoms and a terminal or internal double bond by sulfonation with gaseous sulfur trioxide and subsequent alkaline or acid hydrolysis of the sulfonation products. Also suitable are alkane sulfonates having 12 to 18 C atoms and the esters of α-sulfo fatty acids (ester sulfonates), for example the α-sulfonated methyl esters of hydrogenated coconut fatty acid, palm kernel fatty acid or tallow fatty acid.

Alkylbenzene sulfonates are preferably selected from linear or branched alkylbenzene sulfonates of the formula

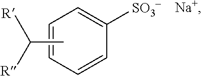

in which R′ and R″ independently are H or alkyl and together contain 9 to 19, preferably 9 to 15 and in particular 9 to 13 C atoms. One very particularly preferred representative is sodium dodecyl benzenesulfonate.

As alk(en)yl sulfates, preference is given to the salts of the sulfuric acid half-esters of fatty alcohols having 12 to 18 C atoms, for example from coconut fatty alcohol, tallow fatty alcohol, lauryl, myristyl, cetyl or stearyl alcohol or the oxo alcohols having 10 to 20 C atoms and those half-esters of secondary alcohols of these chain lengths. For technical reasons relating to washing, preference is given to the alkyl sulfates having 12 to 16 C atoms and alkyl sulfates having 12 to 15 C atoms, as well as alkyl sulfates having 14 or 15 C atoms. 2,3-Alkyl sulfates are also suitable anionic surfactants.

Alkyl ether sulfates having the formula

R¹—O-(AO)ₙ—SO₃⁻X⁺

are also suitable. In this formula, R¹ represents a linear or branched, substituted or unsubstituted alkyl radical, preferably a linear, unsubstituted alkyl radical, particularly preferably a fatty alcohol radical. Preferred radicals R¹ are selected from decyl, undecyl, dodecyl, tridecyl, tetradecyl, pentadecyl, hexadecyl, heptadecyl, octadecyl, nonadecyl, eicosyl radicals and mixtures thereof, preference being given to those representatives having an even number of C atoms. Particularly preferred radicals R¹ are derived from fatty alcohols having 12 to 18 C atoms, for example from coconut fatty alcohol, tallow fatty alcohol, lauryl, myristyl, cetyl or stearyl alcohol or from oxo alcohols having 10 to 20 C atoms.

AO represents an ethylene oxide (EO) or propylene oxide (PO) group, preferably an ethylene oxide group. The index n represents an integer from 1 to 50, preferably from 1 to 20, and in particular from 2 to 10. Very particularly preferably, n represents the numbers 2, 3, 4, 5, 6, 7 or 8. X⁺ represents a monovalent cation or the n^{th} moiety of an n-valent cation, preference being given here to the alkali metal ions and among these to Na⁺ or K⁺, extreme preference being given to Na⁺. Further cations X⁺ may be selected from NH4⁺, ½Zn²⁺, ½Mg²⁺, ½Ca²⁺, ½Mn²⁺, and mixtures thereof.

Particularly preferred detergents contain an alkyl ether sulfate selected from fatty alcohol ether sulfates of formula

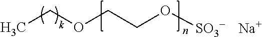

where k=11 to 19, n =2, 3, 4, 5, 6, 7 or 8. Very particularly preferred representatives are Na fatty alcohol ether sulfates having 12 to 14 C atoms and 2 EO (k=11-13, n=2 in formula A-1). The specified degree of ethoxylation is a statistical average which may be an integer or a fractional number for a specific product. The specified degrees of alkoxylation are statistical averages which may be an integer or a fractional number for a specific product. Preferred alkoxylates/ethoxylates have a narrowed homolog distribution (narrow range ethoxylates, NREs).

The anionic surfactants including the fatty acid soaps may be in the form of their sodium, potassium, magnesium or ammonium salts. Preferably, the anionic surfactants are in the form of their sodium salts and/or ammonium salts. Amines which can be used for neutralizing purposes are preferably choline, triethylamine, monoethanolamine, diethanolamine, triethanolamine, methylethylamine or a mixture thereof, preference being given to monoethanolamine.

In different embodiments, at least one non-ionic surfactant is used.

Suitable non-ionic surfactants include alkoxylated fatty alcohols, alkoxylated oxo alcohols, alkoxylated fatty acid alkyl esters, fatty acid amides, alkoxylated fatty acid amides, polyhydroxy fatty acid amides, alkylphenol polyglycol ethers, amine oxides, alkyl (poly)glucosides and mixtures thereof.

Preferred detergents contain at least one fatty alcohol alkoxylate of the formula

R²—O-(AO)ₘ—H,

in which
R² represents a linear or branched, substituted or unsubstituted alkyl radical;
AO represents an ethylene oxide (EO) or propylene oxide (PO) group,
m represents integers from 1 to 50.

In the above formula, R² represents a linear or branched, substituted or unsubstituted alkyl radical, preferably a linear, unsubstituted alkyl radical, particularly preferably a fatty alcohol radical. Preferred radicals R² are selected from decyl, undecyl, dodecyl, tridecyl, tetradecyl, pentadecyl, hexadecyl, heptadecyl, octadecyl, nonadecyl, eicosyl radicals and mixtures thereof, preference being given to those representatives having an even number of C atoms. Particularly preferred radicals R² are derived from fatty alcohols having 12 to 18 C atoms, for example from coconut fatty alcohol, tallow fatty alcohol, lauryl, myristyl, cetyl or stearyl alcohol or from oxo alcohols having 10 to 20 C atoms.

AO represents an ethylene oxide (EO) or propylene oxide (PO) group, preferably an ethylene oxide group. The index m represents an integer from 1 to 50, preferably from 1 to 20, and in particular from 2 to 10. Very particularly preferably, m represents the numbers 2, 3, 4, 5, 6, 7 or 8.

To sum up, particularly preferred fatty alcohol alkoxylates are those of formula

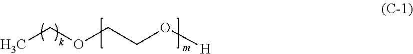

where k=11 to 19, n=2, 3, 4, 5, 6, 7 or 8. Very particularly preferred representatives are fatty alcohols having 12 to 18 C atoms and 7 EO (k=11-17, m=7 in formula C-1).

As the amine oxide, use can in principle be made of any amine oxides established for this purpose in the prior art, that is to say compounds which have the formula R¹R²R³NO, in which each R² and R³ independently of the others is an optionally substituted hydrocarbon chain having 1 to 30 C atoms. Amine oxides which are used with particular preference are those in which R¹ is alkyl having 12 to 18 C atoms and R² and R³ are each independently alkyl having 1 to 4 C atoms, in particular alkyldimethylamine oxides having 12 to 18 C atoms. Examples of representatives of suitable amine oxides are N-cocoalkyl-N,N-dimethylamine oxide, N-tallowalkyl-N,N-dihydroxyethylamine oxide, myristyl/cetyldimethylamine oxide or lauryldimethylamine oxide.

In different embodiments of the invention, use is made of at least one anionic surfactant, in particular an alkylbenzene sulfonate and/or an alkyl ether sulfate, and at least one further non-ionic surfactant, in particular a fatty alcohol ethoxylate.

Preferred detergents contain, based on the total amount of the detergent, 2 to 15% by weight, preferably 5 to 12.5% by weight alkyl ether sulfate(s), in particular fatty alcohol ether sulfate(s), and/or 2.5 to 15% by weight, preferably 5 to 10% by weight alkylbenzene sulfonate(s), in particular alkylbenzene sulfonate(s) having 9 to 13 C atoms.

Further preferred detergents contain, based on the total amount of the detergent, 1 to 15% by weight, preferably 2 to 14% by weight, more preferably 2.5 to 13% by weight, even more preferably 3 to 10% by weight and in particular 4 to 9% by weight fatty alcohol ethoxylate(s).

In different embodiments, the total amount of non-ionic surfactants, based on the weight of the detergent, is 2 to 15% by weight, preferably 5 to 10% by weight.

In different embodiments, the detergents contain alkylbenzene sulfonates, alkyl ether sulfates and fatty alcohol ethoxylates, preferably in the amounts specified above.

It has proven to be advantageous for the cold washing performance if the detergents additionally contain soap(s). Preferred detergents are therefore characterized in that they contain—based on their weight—0.25 to 15% by weight, preferably 0.5 to 12.5% by weight, more preferably 1 to 10% by weight, even more preferably 1.5 to 7.5% by weight and in particular 2 to 6% by weight soap(s). Particular preference is given to soaps of C₁₂-C₁₈ fatty acids.

The detergent may additionally contain further ingredients which further improve the use properties and/or esthetic properties of the detergent. In the context of the present invention, the detergent preferably additionally contains one or more substances selected from the group consisting of enzymes, bleaching agents, complexing agents, builders, electrolytes, non-aqueous solvents, pH adjusters, further odorous substances, perfume carriers, fluorescing agents, colorants, hydrotropes, foam inhibitors, silicone oils, anti-redeposition agents, graying inhibitors, run preventers, anti-crease agents, color transfer inhibitors, antimicrobial active substances, germicides, fungicides, antioxidants, preservatives, corrosion inhibitors, anti-static agents, bittering agents, ironing auxiliaries, waterproofing and impregnation agents, swelling and anti-slip agents, plasticizing components and UV absorbers.

The detergent preferably contains at least one enzyme. In this regard, all enzymes established for these purposes in the prior art can in principle be used. It preferably contains one or more enzymes which can display catalytic activity in a detergent, in particular a protease, amylase, lipase, cellulase, hemicellulase, mannanase, pectin-cleaving enzyme, tannase, xylanase, xanthanase, β-glucosidase, carrageenase, perhydrolase, oxidase, oxidoreductase and mixtures thereof. Preferred hydrolytic enzymes include in particular proteases, amylases, in particular α-amylases, cellulases, lipases, hemicellulases, in particular pectinases, mannanases, β-glucanases, and mixtures thereof. Particular preference is given to proteases, amylases and/or lipases and mixtures thereof, and very particular preference is given to proteases. These enzymes are in principle of natural origin. Improved variants stemming from the natural molecules are available for use in detergents, and these are used with preference.

The enzymes to be used can also be formulated together with accompanying substances, for instance from the fermentation, or with stabilizers.

As bleaching agents, use may be made of any substances which, through oxidation, reduction or adsorption, destroy or pick up dyes and thus decolorize materials. These include, inter alia, hypohalite-containing bleaching agents, hydrogen peroxide, perborate, percarbonate, peroxoacetic acid, diperoxoazelaic acid, diperoxododecanedioic acid and oxidative enzyme systems.

As builders which may be contained in the detergent, mention may be made in particular of silicates, aluminum silicates (in particular zeolites), carbonates, salts of organic di- and polycarboxylic acids, and mixture of these substances.

Organic builders which may be present in the detergent are for example the polycarboxylic acids which can be used in the form of their sodium salts, wherein polycarboxylic acids are to be understood to mean those carboxylic acids which carry more than one acid function. By way of example, these are citric acid, adipic acid, succinic acid, glutaric acid, malic acid, tartaric acid, maleic acid, fumaric acid, saccharic acids, aminocarboxylic acids, and mixtures thereof. Preferred salts are the salts of the polycarboxylic acids, such as citric acid, adipic acid, succinic acid, glutaric acid, tartaric acid, saccharic acids and mixtures thereof.

Polymeric polycarboxylates are also suitable as builders. These are for example the alkali metal salts of polyacrylic acid or of polymethacrylic acid, for example those having a relative molecular mass of 600 to 750,000 g/mol.

Suitable polymers are in particular polyacrylates which preferably have a molecular mass of 1000 to 15,000 g/mol. Due to their superior solubility, preference may in turn be given in this group to the short-chain polyacrylates which have molar masses of from 1000 to 10,000 g/mol, and particularly preferably from 1000 to 5000 g/mol.

Copolymeric polycarboxylates are also suitable, in particular those of acrylic acid with methacrylic acid and of acrylic acid or methacrylic acid with maleic acid. In order to improve the solubility in water, the polymers may also contain allylsulfonic acids, such as allyloxybenzenesulfonic acid and methallylsulfonic acid, as monomer.

In liquid detergents, use is preferably made of soluble builders, such as for example citric acid, or acrylic polymers having a molar mass of 1000 to 5000 g/mol.

Preferred detergents are liquid and preferably contain water as the main solvent. In this case, it is preferred that the detergent contains more than 5% by weight, preferably more than 15% by weight and particularly preferably more than 25% by weight water, in each case based on the total amount of detergent. Particularly preferred liquid detergents contain—based on their weight—5 to 90% by weight, preferably 10 to 85% by weight, particularly preferably 25 to 75% by weight and in particular 35 to 65% by weight water. Alternatively, the detergents may be detergents having a low to zero water content, wherein in one preferred embodiment the water content is less than 10% by weight and more preferably less than 8% by weight, in each case based on the total liquid detergent.

In addition, non-aqueous solvents may be added to the detergent. Suitable non-aqueous solvents include monovalent or polyvalent alcohols, alkanolamines or glycol ethers, in so far as these in the specified concentration range are miscible with water. Preferably, the solvents are selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, propylene glycol t-butyl ether, di-n-octyl ether and mixtures of these solvents. However, it is preferred that the detergent contains an alcohol, in particular ethanol and/or glycerol, in amounts of between 0.5 and 5% by weight, based on the total detergent.

The detergents described herein, in particular the described detergents having a low to zero water content, may be filled into a water-soluble casing and may thus be part of a water-soluble package. If the detergent is packaged in a water-soluble casing, it is preferred that the water content is less than 10% by weight, based on the total detergent, and that anionic surfactants, if present, are in the form of their ammonium salts.

Neutralization with amines does not lead to the formation of water, unlike in the case of bases such as NaOH or KOH. It is thus possible to produce detergents with a low water content which are directly suitable for use in water-soluble casings.

A water-soluble package contains, in addition to the detergent, also a water-soluble casing. The water-soluble casing is preferably formed by a water-soluble film material.

Such water-soluble packages can be produced either by vertical form fill seal (VFFS) methods or by hot-forming methods.

The hot-forming method generally includes forming a first layer from a water-soluble film material in order to create indentations for accommodating a composition therein, filling the composition into the indentations, covering the indentations, which are filled with the composition, with a second layer of a water-soluble film material, and sealing the first and second layers to one another at least around the indentations.

The water-soluble casing is preferably formed from a water-soluble film material selected from the group consisting of polymers or polymer mixtures. The casing may be formed from one or from two or more layers of the water-soluble film material. The water-soluble film material of the first layer and of the further layers, if present, may be identical or different.

The water-soluble package, comprising the detergent and the water-soluble casing, may have one or more chambers. The liquid detergent may be contained in one or more chambers, if present, of the water-soluble casing. The amount of liquid detergent preferably corresponds to one full dose or half the dose required for a washing cycle.

It is preferred that the water-soluble casing contains polyvinyl alcohol or a polyvinyl alcohol copolymer.

Suitable water-soluble films for producing the water-soluble casing are preferably based on a polyvinyl alcohol or a polyvinyl alcohol copolymer, the molecular weight of which lies in the range from 10,000 to 1,000,000 g/mol, preferably from 20,000 to 500,000 g/mol, particularly preferably from 30,000 to 100,000 g/mol and in particular from 40,000 to 80,000 g/mol.

Polymers may additionally be added to a film material suitable for producing the water-soluble casing, said polymers being selected from the group comprising acrylic acid-containing polymers, polyacrylamides, oxazoline polymers, polystyrene sulfonates, polyurethanes, polyesters, polyether polylactic acid, and/or mixtures of the aforementioned polymers.

Preferred polyvinyl alcohol copolymers include, besides vinyl alcohol, dicarboxylic acids as further monomers. Suitable dicarboxylic acids are itaconic acid, malonic acid, succinic acid and mixtures thereof, preference being given to itaconic acid.

Likewise preferred polyvinyl alcohol copolymers include, besides vinyl alcohol, an ethylenically unsaturated carboxylic acid, the salt thereof or the ester thereof. With particular preference, such polyvinyl alcohol copolymers contain, besides vinyl alcohol, acrylic acid, methacrylic acid, acrylic acid ester, methacrylic acid ester or mixtures thereof.

Suitable water-soluble films for use in the casings of the water-soluble packages according to the invention are films which are sold by the company MonoSol LLC for example under the name M8630, C8400 or M8900. Other suitable films include films named Solublon® PT, Solublon® GA, Solublon® KC or Solublon® KL from Aicello Chemical Europe GmbH or the VF-HP films from Kuraray.

The water-soluble packages may have a substantially shape-stable ball-like and cushion-like configuration with a circular, elliptical, square or rectangular basic shape.

The water-soluble package may have one or more chambers for storing one or more detergents. If the water-soluble package has two or more chambers, at least one chamber contains a liquid detergent. The other chambers may each contain a solid or a liquid detergent.

Also described herein is a washing method comprising the method steps
(a) providing a washing solution including a liquid detergent as described herein, and
(b) bringing a textile into contact with the washing solution according to (a).

Methods for cleaning textiles are generally characterized in that, in a plurality of method steps, different active cleaning substances are applied to the article to be cleaned and are washed off after the treatment time, or in that the article to be cleaned is treated in some other way with a detergent or a solution of said detergent.

In different embodiments of the invention, temperatures of 50° C. or less, for example 30° C. or less, are used in the described washing method. These specified temperatures refer to the temperatures used in the washing steps.

All the details, subject matters and embodiments which are described in respect of the detergents can also be applied to the washing method and to the use, and vice versa.

### EXAMPLE

1 g of a solution consisting of 1% by weight ionic surfactant, 0.1% by weight fungicides, 0.5% by weight odorous substance, 2% by weight polymer according to the invention and 96.4% by weight water was diluted with water to a volume of 1500 ml and stirred for 3 minutes. A reference without added polymer was used as a benchmark. Cotton (WfK 10-A size approx.: 25*19 cm) was then placed into the solution and the cotton was stirred therein for 30 minutes. The cotton was then washed twice with in each case 1500 ml and then samples were analyzed for scent in the wet state, immediately after being washed (table 1) and 24 hours after being washed (table 2).
Polymer 1: HPMC
Polymer 2: Na-CMC
Polymer 3: PVA-PEG copolymer
Polymer 4: Vinylpyrrolidone-vinylimidazole copolymer
Polymer 5: CMC
Polymer 6: Quaternized HEC
Polymer 7: Polyester PPT (not according to the invention)

TABLE 1
Smell test on the freshly washed, wet textile article

| | Polymer | | | | | | | |
|---|---|---|---|---|---|---|---|---|
| | — | 1 | 2 | 7 | 3 | 4 | 5 | 6 |
| Person 1 | 3 | 4 | 5 | 4 | 4 | 6 | 6 | 10 |
| Person 2 | 4 | 5 | 5 | 5 | 5 | 5 | 5 | 8 |
| Person 3 | 4 | 5 | 4 | 6 | 7 | 8 | 8 | 10 |
| Person 4 | 4 | 5 | 6 | 3 | 4 | 3 | 4 | 5 |
| Person 5 | 3 | 4 | 4 | 3 | 3 | 3 | 4 | 5 |
| Person 6 | 7 | 6 | 8 | 6 | 10 | 7 | 7 | 6 |
| Person 7 | 7 | 7 | 8 | 8 | 6 | 5 | 4 | 6 |
| Person 8 | 4 | 4 | 2 | 2 | 3 | 3 | 6 | 8 |
| Person 9 | 3 | 6 | 4 | 6 | 5 | 5 | 6 | 10 |
| Person 10 | 4 | 4 | 5 | 6 | 6 | 6 | 7 | 10 |
| Average | 4.3 | 5.0 | 5.1 | 4.9 | 5.3 | 5.1 | 5.7 | 7.8 |

TABLE 2
Smell test on the dry textile (24 hours after the washing process)

| | — | 1 | 2 | 7 | 3 | 4 | 5 | 6 |
|---|---|---|---|---|---|---|---|---|
| Person 1 | 3 | 3 | 3 | 5 | 3 | 3 | 3 | 7 |
| Person 2 | 2 | 4 | 4 | 3 | 4 | 4 | 4 | 6 |
| Person 3 | 3 | 7 | 5 | 4 | 5 | 4 | 8 | 8 |
| Person 4 | 3 | 6 | 5 | 3 | 5 | 5 | 6 | 7 |
| Person 5 | 4 | 5 | 4 | 3 | 3 | 4 | 4 | 6 |
| Person 6 | 3 | 6 | 5 | 3 | 5 | 2 | 2 | 5 |
| Person 7 | 3 | 4 | 5 | 3 | 4 | 3 | 4 | 6 |
| Person 8 | 2 | 4 | 2 | 2 | 4 | 3 | 3 | 5 |
| Person 9 | 3 | 4 | 3 | 2 | 4 | 3 | 2 | 5 |
| Person 10 | 2 | 3 | 2 | 2 | 3 | 3 | 3 | 4 |
| Average | 2.8 | 4.6 | 3.8 | 3.0 | 4.0 | 3.4 | 3.9 | 5.9 |

Intensity from 0 to 10, where 0 means no scent and 10 means a strong scent.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A liquid detergent containing at least one polymer selected from the group consisting of cotton, cellulose, cellulose ether, lignin, polyvinyl acetate-polyalkylene glycol copolymer, polyvinylpyrrolidone-polyvinylimidazole copolymer, polyalkylene glycol polyester, polyamine and a mixture thereof and at least one odorous substance.

2. The detergent according to claim 1, wherein
(i) the cellulose or cellulose ether is a polymer having units of formula 1 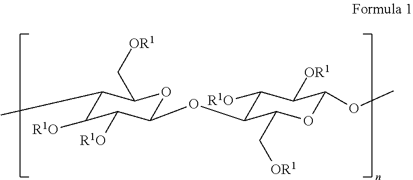
wherein n is 25 to 10,000, preferably 50 to 5000, and each R¹ independently is hydrogen or a linear or branched alkyl having 1 to 6 C atoms, preferably 1 to 4 C atoms, preferably methyl, ethyl or isopropyl, and alkyl is optionally substituted with —OH, —COOH and/or —N⁺(R^{a})(R^{b})(R^{c}) X⁻, wherein each R^{a}, R^{b} and R^{c} independently is a linear or branched alkyl having 1 to 6 C atoms, preferably 1 to 4 C atoms, preferably methyl and/or ethyl, and X⁻ is any anion; and/or
(ii) the polyvinyl acetate-polyalkylene glycol copolymer is a graft polymer, obtainable from a reaction mixture containing polyalkylene glycol, preferably polyethylene glycol, polypropylene glycol and/or polybutylene glycol, preferably polyethylene glycol, and vinyl acetate; and/or
(iii) the polyalkylene glycol polyester is obtainable from a reaction mixture comprising at least one polyol, wherein the at least one polyol is preferably an alkyl diol having 2 to 6 C atoms, preferably ethylene glycol, propylene glycol and/or butylene glycol, particularly preferably ethylene glycol, and at least one aryl polycarboxylic acid, wherein the at least one aryl polycarboxylic acid preferably comprises 5 to 14 C atoms, preferably 6 C atoms, and 2 to 5 —COOH, preferably 2 or 3 —COOH, and preferably 2 —COOH, and is particularly preferably selected from the group consisting of phthalic acid, isophthalic acid, terephthalic acid and a mixture thereof and even more preferably is terephthalic acid.

3. The detergent according to claim 1, comprising 0.01 to 10% by weight of the at least one polymer.

4. The detergent according to claim 1, wherein the cellulose ether is selected from the group consisting of hydroxypropyl methyl cellulose (HPMC), methyl cellulose (MC), methyl ethyl cellulose (MEC), carboxyl methyl cellulose (CMC), 2-hydroxyethyl-2-[2-hydroxy-3-(trimethylammonio)propoxy]ethyl-2-hydroxy-3-(trimethylammonio)propyl cellulose ether chloride and a mixture thereof.

5. The detergent according to claim 1, comprising at least one further constituent selected from the group consisting of enzymes, builders, bleaching agents, electrolytes, non-aqueous solvents, pH adjusters, further odorous substances, perfume carriers, fluorescing agents, colorants, hydrotropes, foam inhibitors, silicone oils, anti-redeposition agents, graying inhibitors, run preventers, anti-crease agents, color transfer inhibitors, antimicrobial active substances, germicides, fungicides, antioxidants, preservatives, corrosion inhibitors, anti-static agents, bittering agents, ironing auxiliaries, waterproofing and impregnation agents, swelling and anti-slip agents, plasticizing components and UV absorbers.

6. A washing method comprising the method steps
(a) providing a washing solution including a liquid detergent according to claim 1, and
(b) bringing a textile into contact with the washing solution according to (a).
